(19) United States
(12) Patent Application Publication
(10) Pub. No.: US 2003/0133191 A1
(43) Pub. Date: Jul. 17, 2003

(54) Three-dimensional observation apparatus

(76) Inventors: Kazuo Morita, Tokyo (JP); Susumu Takahashi, Iruma-shi (JP)

Correspondence Address: Arnold International, P.O. Box 585, Great Falls, VA, 22066, US

(21) Appl. No.: 10/270,641

(22) Filed: Oct. 16, 2002

(30) Foreign Application Priority Data
Jan. 16, 2002 (JP) 2002-007780

(51) Int. Cl. G02B 27/22

(52) U.S. Cl. 359/464; 359/462

(57) ABSTRACT

A 3-D observation apparatus includes a projector and an imaging means of positive refractive power. The projector projects left and right stereo images through respective apertures so that the images overlap. The imaging means forms images of the respective apertures which serve as exit pupils of the 3-D observation apparatus. The imaging means: (1) has its optical axis decentered to prevent the observer's head from interfering with the projector, (2) is formed of either a Fresnel lens or a Fresnel mirror, and (3) is positioned substantially at the overlapped images. A diffuser is provided substantially at the imaging means for the purpose of enlarging the size of the exit pupils, while not allowing them to overlap. In this way, a viewer can comfortably view the overlapped 2-D images and will experience them as 3-D images without having to wear special glasses.

### BACKGROUND OF THE INVENTION

The present invention relates to a three-dimensional (hereinafter 3-D) observation apparatus wherein individuals need not wear glasses in order to view 3-D images using the apparatus. A prior art example of such a 3-D observation apparatus is disclosed in Japanese Laid-Open Patent application S51-24116. As shown in FIG. 20, this 3-D observation apparatus includes two display devices 51R, 51L, two concave mirrors 52R, 52L, and a concave mirror 53 that faces the two concave mirrors 52R, 52L. The concave mirrors 52R, 52L have the same radius of curvature and a common center of curvature. The observer's right and left eyes 54R, 54L are also shown in FIG. 20.

FIG. 21 is a side view of the 3-D observation apparatus in FIG. 20. FIG. 21 shows the unit upside down, for convenience, in order to explain the apparatus and with the display devices omitted. In FIG. 21, 54R′ (54L′), 54R″ (54L″) are conjugate points to the viewer's respective right and left eyes within the 3-D observation apparatus. The display devices 51R (51L) shown in FIG. 20 are disposed somewhere between the infinity positions PR(∞) (PL(∞)) and the focal point PR(f) (PL(f)). When the display devices 51R (51L) are disposed at the infinity positions PR(∞) (PL(∞)), light emerging from the display devices 51R (51L) is reflected on the concave mirrors 52R (52L) and is imaged at the front focal point A of the concave mirror 53. The light is then again reflected on the concave mirror 53 where it is collimated. The collimated light then reaches the viewer's pupil 54R (54L). When the display devices 51R (51L) are positioned at the front focal positions PR(f) (PL(f)) of the concave mirrors 52R (52L), light emerging from the display devices 51R (51L) is reflected on the concave mirrors 52R (52L) where it is collimated. The collimated light is again reflected on the concave mirror 53 and imaged at the rear focal point B of the concave mirror 53. Then, the light reaches the viewer's eyes where it is viewed as an enlarged image. Such a conventional observation apparatus does not use a beam splitter (i.e., a half-reflecting mirror), and thus bright 3-D images can be seen.

As in the 3-D observation apparatus described above, a large shift between the viewing points and the focal points spoils the stereoscopy observation. In this 3-D observation apparatus, the concave mirrors that produce distortion in images face each other. These two facing concave mirrors should be positioned so that their respective distortions cancel each other. Positioning errors of the concave mirrors determine the magnitude of image distortion and focal point shift. To avoid these problems, the two concave mirrors should have precisely formed surfaces and be positioned with the least error. This results in a high cost for manufacturing and assembling the concave mirrors. Because the viewer faces the concave mirrors, a shift in the viewing position leads to a large image distortion, giving the viewer less freedom of viewing position and posture, which is inconvenient to the viewer. The exit pupils can be enlarged to improve freedom of movement during observation. However, larger concave mirrors are required in association with the enlarged exit pupil in the prior art observation apparatus discussed above. This will enlarge the entire 3-D observation apparatus.

U.S. Pat. No. 5,712,732 discusses, beginning at column 1, line 41, a prior art stereoscopic display wherein stereo pair images are projected, at slightly different angles, onto the back of a Fresnel lens so as to create a 3-D viewing experience for an observer without glasses. However, there is no suggestion that the Fresnel lens have its optical axis offset from the center of the Fresnel lens, as in the present invention.

U.S. Pat. No. 5,614,941 discloses a prior art stereoscopic display wherein stereo pair images are projected, at slightly different angles, onto a viewing screen that includes an array of cylinder lenses, a diffuser, and a Fresnel lens so as to create a 3-D viewing experience for an observer without glasses. Once again, however, there is no suggestion that the Fresnel lens have its optical axis offset from the center of the Fresnel lens, as in the present invention.

### BRIEF SUMMARY OF THE INVENTION

The objects of the present invention are to provide an individual 3-D observation apparatus and a 3-D observation system that does not require the observer to wear glasses and which provides bright images, more freedom of positioning of the viewer's head, and reduced aberrations due to misalignment of viewer's pupils from the optical axes of the exit pupils. An additional object of the invention is to allow the viewer to assume one or more comfortable viewing postures during a 3-D observation.

### BRIEF DESCRIPTION OF THE DRAWINGS

The present invention will become more fully understood from the detailed description given below and the accompanying drawings, which are given by way of illustration only and thus are not limitative of the present invention, wherein:

FIGS. 1(a) and 1(b) are illustrations to explain the principle of the 3-D observation apparatus of the present invention, with FIG. 1(a) being a transmission-type 3-D observation apparatus and FIG. 1(b) being a reflection-type 3-D observation apparatus;

FIG. 2 is an illustration to explain the principle of enlarging the viewing pupils in the 3-D observation apparatus of the present invention;

FIGS. 3(a) and 3(b) show an embodiment of the 3-D observation apparatus of the present invention, with FIG. 3(a) being a top view and FIG. 3(b) being a side view;

FIGS. 4(a) and 4(b) show another embodiment of the 3-D observation apparatus of the present invention, with FIG. 4(a) being a perspective view and FIG. 4(b) being a side view;

FIG. 5 is a side view which shows the embodiment of FIG. 4 in more detail;

FIGS. 6(a), 6(b) and 6(c) are side views to schematically illustrate three respective modifications to the embodiment illustrated in FIG. 5;

FIGS. 7(a) and 7(b) are side views to schematically illustrate two additional embodiments of the 3-D observation apparatus of the present invention;

FIGS. 8(a) and 8(b) illustrate a reflection-type display panel applicable to the reflection-type 3-D observation apparatus of the present invention, with FIG. 8(a) being a perspective view and FIG. 8(b) being a side view;

FIGS. 9(a) and 9(b) are schematic illustrations of another example of a reflection-type display panel applicable to the reflection-type 3-D observation apparatus of the present invention, with FIG. 9(a) being a side view and FIG. 9(b) being an enlarged view of the diffuser;

FIG. 10 is a side view to schematically show another example of a reflection-type display panel applicable to the reflection-type 3-D observation apparatus of the present invention;

FIG. 11 is a side view to schematically illustrate another example of the reflection-type display panel applicable to the reflection-type 3-D observation apparatus of the present invention;

FIGS. 12(a)-12(c) show another example of a reflection-type display panel applicable to the reflection-type 3-D observation apparatus of the present invention, with FIG. 12(a) being a side view, FIG. 12(b) being a side view that illustrates a modification to FIG. 12(a), and FIG. 12(c) being an expanded view of the diffusing film layer 5d shown in FIGS. 12(a) and 12(b);

FIGS. 13(a)-13(c) show other examples of a reflection-type display panel applicable to the 3-D observation apparatus of the present invention, with FIG. 13(a) being a side view, FIG. 13(b) being a side view that illustrates a modification of the panel shown in FIG. 13(a), and FIG. 13(c) being an expanded view of the layer 5e that illustrates diffusion of light;

FIGS. 14(a) and 14(b) show an arrangement of a reflection-type 3-D observation apparatus of the present invention having any of the structures shown in the embodiments discussed above, with FIG. 14(a) being a perspective view and FIG. 14(b) being a top view;

FIG. 15 shows the configuration of an embodiment of a 3-D observation system that uses the 3-D observation apparatus of the present invention;

FIG. 16 shows an application of the 3-D observation apparatus of the present invention;

FIG. 17 shows another application of the 3-D observation apparatus of the present invention;

FIG. 18 shows another application of the 3-D observation apparatus of the present invention;

FIG. 19 shows another application of the 3-D observation apparatus of the present invention;

FIG. 20 schematically illustrates the structure of a prior art, reflection-type 3-D observation apparatus; and

FIG. 21 is a side view of the device shown in FIG. 20.

### DETAILED DESCRIPTION

The 3-D observation apparatus of the present invention projects light beams that convey left and right stereo image data through respective apertures. The light beams converge so as to form overlapped images within a common region. Images for viewing are formed at the exit pupils of the 3-D observation apparatus by an imaging means which is formed of either a Fresnel lens or Fresnel mirror that is positioned substantially at the common region. In addition, a diffuser for enlarging the pupils is preferably provided substantially at the common region. The diffuser should not enlarge the projected images of the two apertures to the point that the two apertures overlap. In this way, light fluxes having parallax that are projected onto a display surface from the two apertures are imaged so that the exit pupils are enlarged but do not overlap. Thus, the exit pupils serve to display left and right images having different parallax, to the respective left and right eye of a viewer, thereby providing a 3-D viewing experience to a viewer without the need for the viewer to wear glasses in order to experience the 3-D effect.

With the structure of the 3-D observation apparatus of the present invention described above, in which the left and right images are projected onto a common region, the convergence point for the light passing through the left and right pupils is made to coincide with the image surface of the left and right images, so that the left and right images overlap. With the left and right apertures enlarged and projected onto the viewing pupil positions, more freedom of pupil positions is obtained, thereby allowing the viewer to be in a more comfortable posture during observation. The diffuser enables the size of the pupils of the projectors to be reduced, which results in improved image quality, as well as enables the size of the projectors to be reduced. The diffuser is also used to reduce differences in aberrations in the projection optics, and it serves to make the light more uniform, which improves the 3-D viewing experience.

The imaging means for forming the left and right images, as well as the pupil enlarging effect provided at the left and right exit pupils, also reduces aberrations in the 3-D image. In the 3-D observation apparatus of the present invention, the imaging optical system for creating the exit pupils and the diffuser for enlarging the exit pupils can be provided as components on a display panel. The display panel can be planar, in which case it may be observed from a non normal position so as to reduce image aberrations. Also, the display panel can be curved so as to further reduce image aberrations.

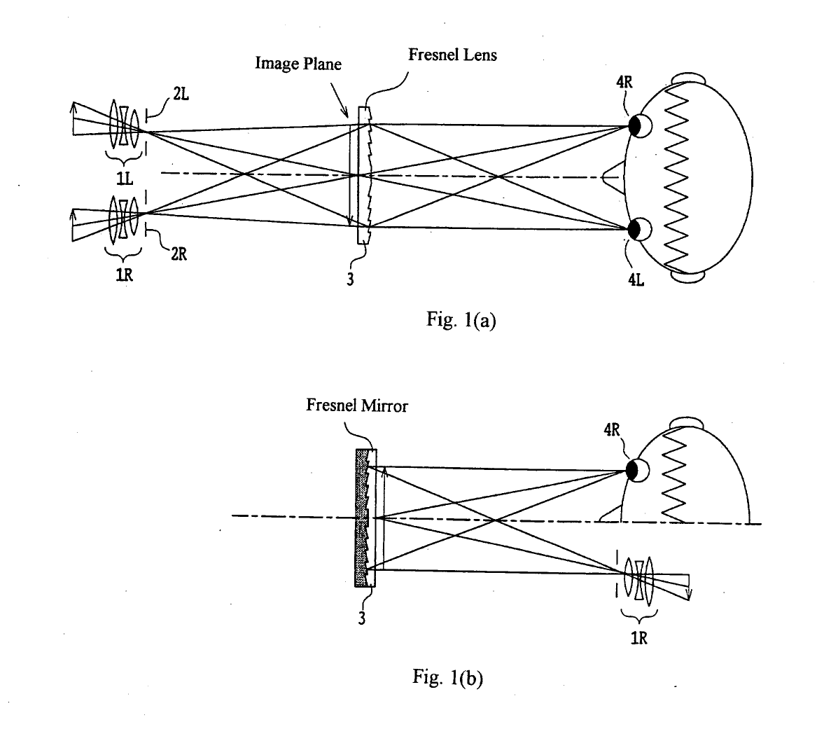

Various embodiments of the present invention will now be described in detail. FIGS. 1(a) and 1(b) show ray paths of two embodiments of a 3-D observation apparatus according to the present invention, with FIG. 1(a) illustrating a transmission-type 3-D observation apparatus and FIG. 1(b) illustrating a reflection-type 3-D observation apparatus. In FIG. 1(b), only the optical structure for conveying images to the right eye is shown (i.e., the structure for the left eye is omitted, for convenience). The 3-D observation apparatus shown in FIGS. 1(a) and 1(b) includes a projection optical system having projectors 1R, 1L, and an imaging optical system 3. Although not illustrated in FIGS. 1(a) and 1(b), a diffuser may be used with the 3-D observation apparatus of the invention, either as a separate component or combined with another component. The projectors 1R, 1L are arranged so as to project images from the two apertures 2R, 2L onto a common region.

The imaging optical system 3 is arranged to form the images from the two apertures 2R, 2L of the projection optical systems at the viewer's pupils 4R, 4L. The diffuser serves to enlarge the viewing pupils. The imaging optical system 3 and the diffuser are positioned at a common region, such as a display surface. The display surface is positioned to coincide with the image plane of the images projected from the projection devices. The imaging optical system 3 is formed of a Fresnel lens in the case of a transmission-type 3-D observation apparatus, and of a Fresnel mirror in the case of a reflection-type 3-D observation apparatus. The Fresnel mirror or Fresnel lens is arranged to form the images from the two apertures 2R, 2L at the viewer's pupils, respectively. Having the Fresnel surface positioned substantially at the image plane keeps the Fresnel surface from impairing the image quality. Further, unlike conventional concave mirrors, the Fresnel surface takes up much less space, since the overall form of such a mirror is similar to that of a flat surface.

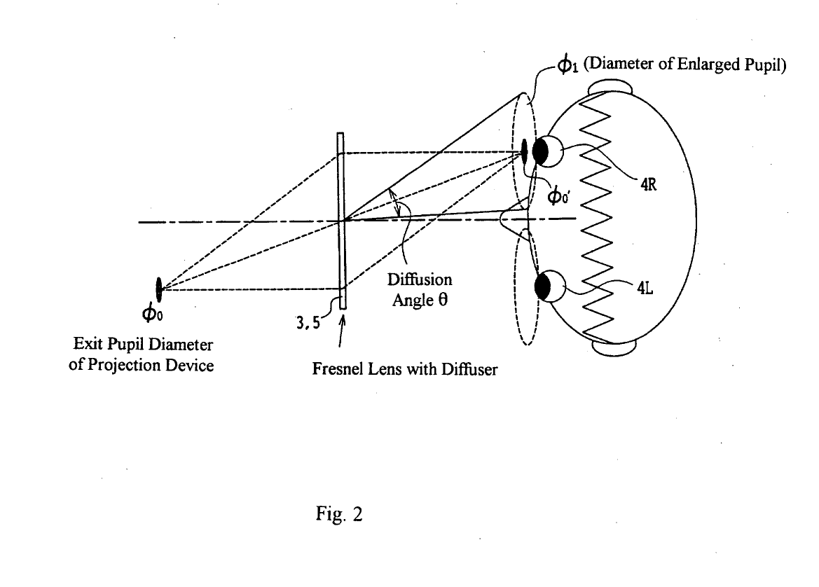

FIG. 2 is an illustration to show the principle of enlarging the viewing pupils in the 3-D observation apparatus of the present invention. In FIG. 2, the structure of a transmission-type 3-D observation apparatus is shown. A diffuser 5 is positioned at or near a flat display surface along with the imaging optical system 3. The imaging optical system 3 serves to form at the exit pupils images having a diameter of φ₀′, of the pupils of the left and right projection devices having a diameter of φ₀. The diffuser 5 provides a diffusion effect that enlarges the images of the pupils of the left and right projection devices to a diameter φ₁. The left and right exit pupils as enlarged by the diffuser 5 are not enlarged to such an extent that the left and right exit pupils overlap. Thus, cross-talk is prevented. Light transits the diffuser 5 when positioned at the display surface only once in a transmission-type 3-D observation apparatus. However, the diffuser is twice as effective in a reflection-type 3-D observation apparatus (not shown in FIG. 2), since the light transits the diffuser twice.

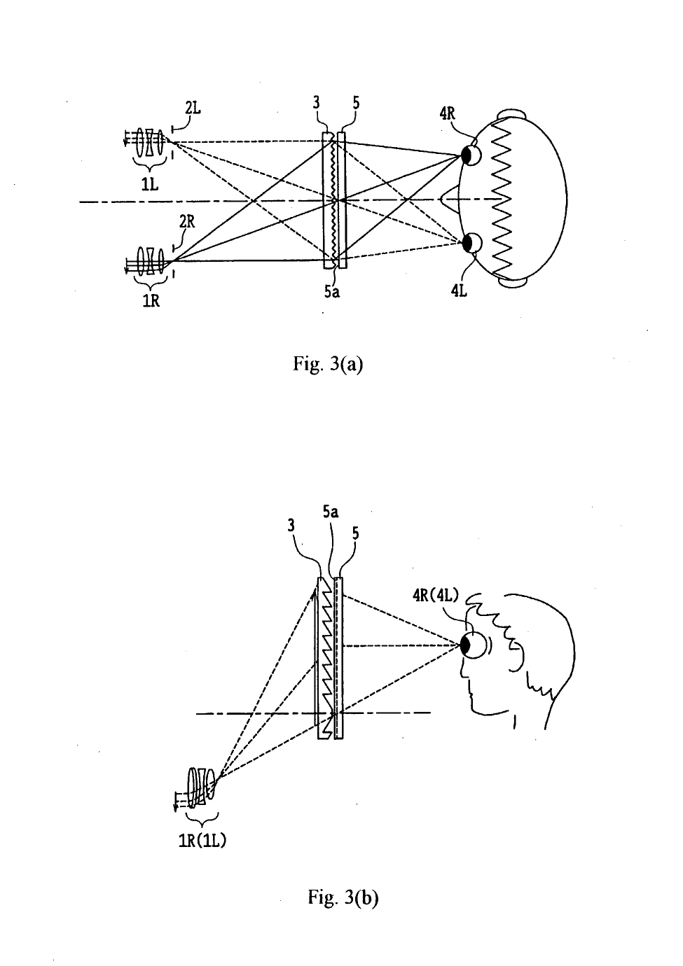

FIGS. 3(a) and 3(b) illustrate an embodiment of the 3-D observation apparatus of the present invention, with FIG. 3(a) being a top schematic view and FIG. 3(b) being a side schematic view. The 3-D observation apparatus of this embodiment is of the transmission-type. An imaging optical system 3 (here formed as a Fresnel lens) is positioned substantially at a display surface or region for forming overlapping images from the apertures 2R, 2L. The projector device in this case is formed of separate projectors 1R, 1L which project image-bearing light through the apertures. The Fresnel lens 3 has its prism-like Fresnel surface on the side of the viewer. A diffuser 5 for enlarging the pupils is formed of a diffusing plate and is positioned near the Fresnel lens 3. The diffuser 5 has a diffusing surface 5a facing the Fresnel lens surface. In this embodiment, the Fresnel lens surface is positioned substantially at the image surface of images projected using the projection devices. Therefore, the Fresnel lens surface does not significantly affect the image quality. The diffusing surface 5a is positioned near the Fresnel lens surface in order to reduce blurriness caused by the diffuser.

The transmission-type display panel of this example consists of a de-centered optical system. In other words, the Fresnel lens has an optical axis that is de-centered with respect to the center of the Fresnel lens surface. As is shown in FIG. 3(b), the optical axis of the Fresnel lens is lower than the center position of the Fresnel lens surface, which has positive refractive power. The de-centered arrangement of the Fresnel lens in this embodiment is useful in positioning the projector so that it does not obstruct the view of the observer. The diffusing surface 5a and the Fresnel surface are preferably arranged to be as near to one another as possible so as to maintain a high quality image.

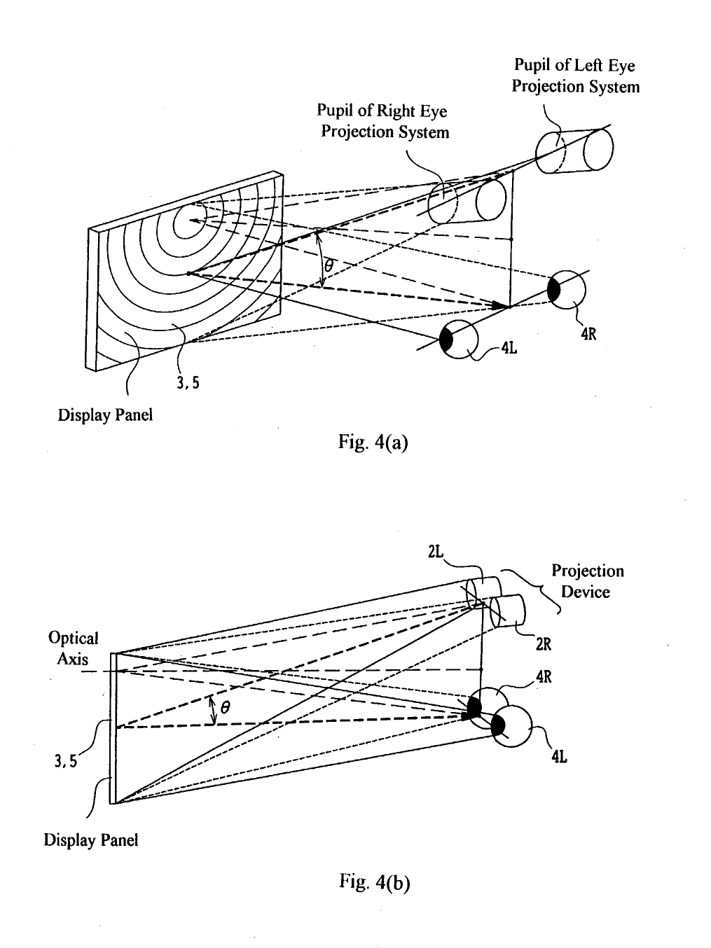

FIGS. 4(a) and 4(b) show another embodiment of the 3-D observation apparatus of the present invention, with FIG. 4(a) bing a perspective view and FIG. 4(b) being a side view. The 3-D observation apparatus of this embodiment is of the reflection-type. The display panel is formed of a Fresnel mirror 3 which is an imaging optical system for forming images from the apertures of the projection devices 2R, 2L at the viewer's pupils 4R, 4L, and a diffuser 5 for enlarging the pupils. For the reflection-type 3-D observation apparatus, optical members should be arranged in a way that the projection devices and the viewer's face do not interfere with each other. It is better for the viewer that he/she directly face the display panel, so that the line of sight is normal to the display panel surface. In this embodiment, θ is defined as the angle between the optical axis of the projected light that is incident onto the display panel and the optical axis of the display light emerging from the center of the display panel. In addition, according to the present invention, the optical axis of the Fresnel mirror 3 is dc-centered in the upward or downward direction (upward in FIG. 4) in relation to the center of the display panel.

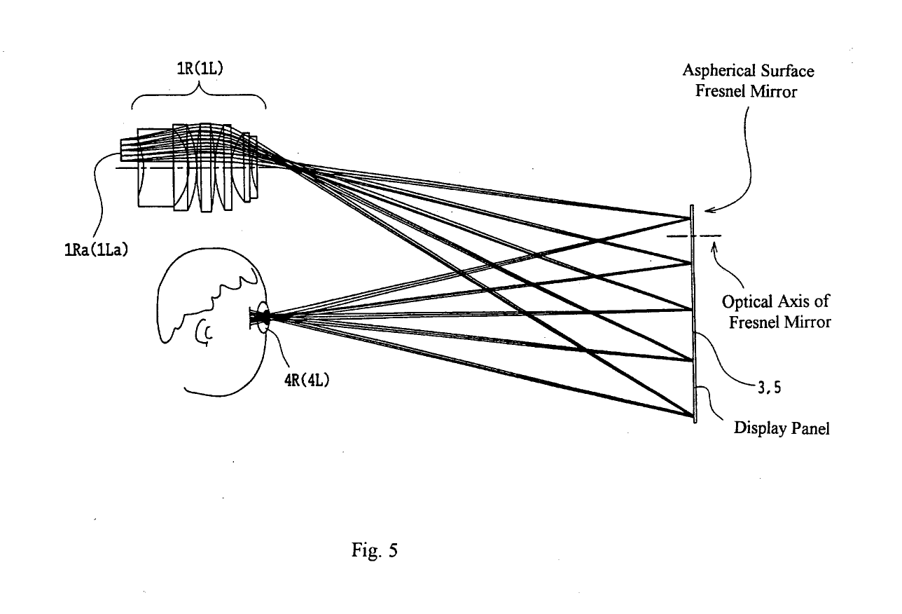

FIG. 5 is a side view to show the embodiment illustrated in FIG. 4 in more detail. In FIG. 5, the projection optical systems 1R (1L) of the projection device are formed of spherical lenses and the respective display surfaces 1Ra (1La) are de-centered from the optical axes of the lenses so that the projection device and the viewer's head do not physically interfere with each other. Preferably, the display panel 3, 5 is positioned and oriented so that the line of sight is normal to the display panel substrate. Once again, in this embodiment, the display panel is a Fresnel mirror surface. It is preferred that the observer views the display panel from the direct front. However, the display panel can be used at an angle of as much as 30°, and high quality images can be assured when the display panel is within 15° of being normal to the line of sight.

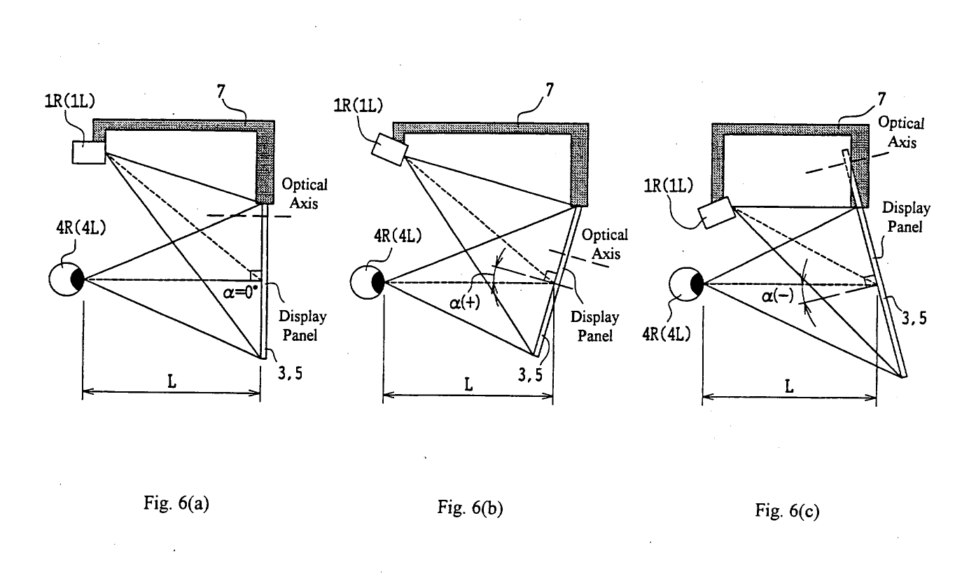

FIGS. 6(a)-6(c) are side views which show possible modifications to the embodiment shown in FIG. 5. In FIGS. 6(a)-6(c), the viewer's line of sight is horizontal. In these alternative embodiments, adjustment is made for the display panel and the viewer's pupils 4R (4L) by a combination of the inclination of the display panel surface and the de-centering magnitude of the optical axis of the de-centered Fresnel lens surface. A supporting arm 7 for supporting the two projection devices and the display panel is shown in FIGS. 6(a)-6(c). The inclination α of the display panel surface is the angle between the line connecting the center of the display panel to the viewer's pupil versus a line drawn orthogonal to the display panel at its center. For comfortable observation, this angle is preferably less than 30°. The angle α of the display panel surface is zero degrees in the 3-D observation apparatus of FIG. 6(a), and 30 degrees in each of the 3-D observation apparatuses of FIGS. 6(b) and 6(c). Among the embodiments shown in FIGS. 6(a)-6(c), the structures shown in FIGS. 6(a) and 6(b) are preferred because they provide more natural viewing and require less de-centering of the optical axis of the Fresnel lens from the center of the Fresnel lens surface.

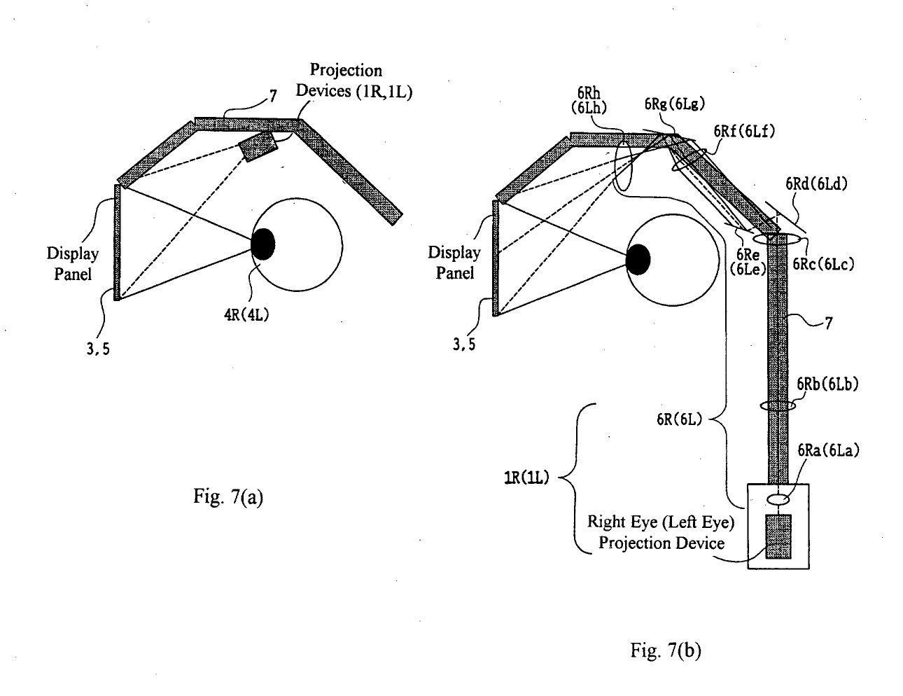

FIGS. 7(a) and 7(b) are side views which schematically show the structure of another embodiment of the 3-D observation apparatus of the present invention. The 3-D observation apparatus of this embodiment is of the reflection-type. The 3-D observation apparatus in FIG. 7(a) is formed of two projection devices and a display panel having a Fresnel mirror 3 and a diffuser 5. The viewing pupils are separated to the left and right and enlarged to form images at the viewer's pupil positions. The 3-D observation apparatus in FIG. 7(b) is formed of the projection optical systems 1R (1L) that are also used in FIG. 7(a) plus additional relay systems. Thus, in addition to the projection devices included in FIG. 7(a), a relay system 6R (6L) is provided in the supporting arm 7 for supporting the display panel. In the embodiment of FIG. 7(b), the relay system 6R (6L) is formed of the lenses 6Ra-6Rc (6La-6Lc), mirrors 6Rd (6Ld), 6Re (6Le), lenses 6Rf (6Lf), mirrors 6Rg (6Lg), and lenses 6Rh (6Lh). With this structure, the projection device and the viewer's head can be sufficiently separated so that any physical interference between them is avoided.

Examples of the display panel used in the 3-D observation apparatus of the present invention will now be described in detail.

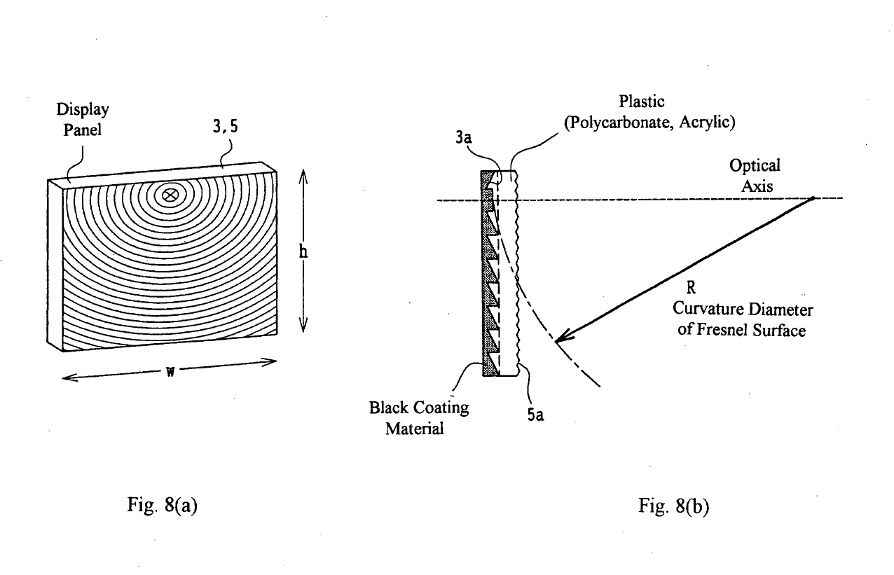

FIGS. 8(a) and 8(b) are illustrations to show an example of a reflection-type display panel that may be used in the reflection-type 3-D observation apparatus of the present invention, with FIG. 8(a) being a perspective view and FIG. 8(b) being a side view to schematically show the structure of the display panel. The display panel of this example is formed of a Fresnel surface 3a and a diffusing surface 5a. The diffusing surface 5a has randomly arranged concave surfaces. The Fresnel surface 3a and diffusing surface 5a are formed into an integral unit. For example, plastic resins such as polycarbonate or acrylic may be used to mold a Fresnel surface and a diffusing surface. The Fresnel surface 3a may then be coated with aluminum to make it reflective. A black coating material may be applied to the back of the Fresnel surface so as to form a protective coating. The Fresnel surface 3a of the display panel now serves to form images by reflection of the apertures of the two projection devices so that a viewer may view the images by placing his eyes at the pupil positions. The diffusing surface 5a serves to enlarge the exit pupils for easier viewing.

The display panel shown in FIGS. 8(a) and 8(b) has the structure of a de-centered, Fresnel back-surface mirror. However, the Fresnel mirror may instead be a front-surface mirror. The radius of curvature R of the Fresnel surface 3a of the front-surface or back-surface mirrors will now be discussed. If the Fresnel mirror is designed as a back-surface mirror, the radius of curvature R should equal 2n·f; however, when the Fresnel mirror is designed to be a front-surface mirror, the radius of curvature R should equal 2f, where n is the refractive index and f is the focal length. Accordingly, by employing a Fresnel back-surface mirror as illustrated in FIGS. 8(a) and 8(b), the radius of curvature can be made larger, which is advantageous in that smaller aberrations are generated in the course of imaging the pupils. Furthermore, the display panel of this example uses an aspherical Fresnel surface 3a with its radius of curvature increased toward the periphery. With this structure, the aspherical surface advantageously serves to further reduce aberrations generated in the course of imaging the pupils.

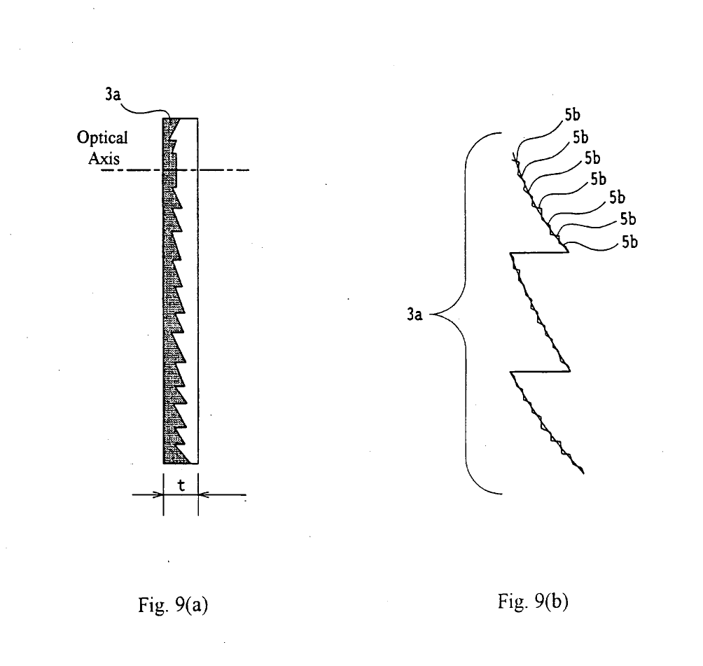

FIGS. 9(a) and 9(b) illustrate another example of a reflection-type display panel applicable to the reflection-type 3-D observation apparatus of the present invention, with FIG. 9(a) being a side view to schematically show the structure, and FIG. 9(b) being an enlarged view of the diffuser. In this example, the diffuser is formed by integrally molding fine concave surfaces 5b as is shown in FIG. 9(b) at the Fresnel surface. This structure can serve in lieu of using a diffuser 5a as shown in FIG. 8(b). Referring again to FIGS. 9(a) and 9(b), the Fresnel surface 3a has a reflective coating applied so as to form a back-surface Fresnel reflecting mirror. In this example, the overall shape of the display panel is that of a flat surface. This enables an anti-reflection coating (not illustrated) to be easily applied to the top surface. Light passes through the diffuser twice in the reflection-type display panel shown in FIG. 8(b). On the other hand, using the Fresnel surface 3a having fine concave surfaces 5b as shown in FIG. 9(b) results in the light being diffused only once by the diffuser. This causes the projected light to have less blurring, and thereby increases the quality of the images that can be viewed.

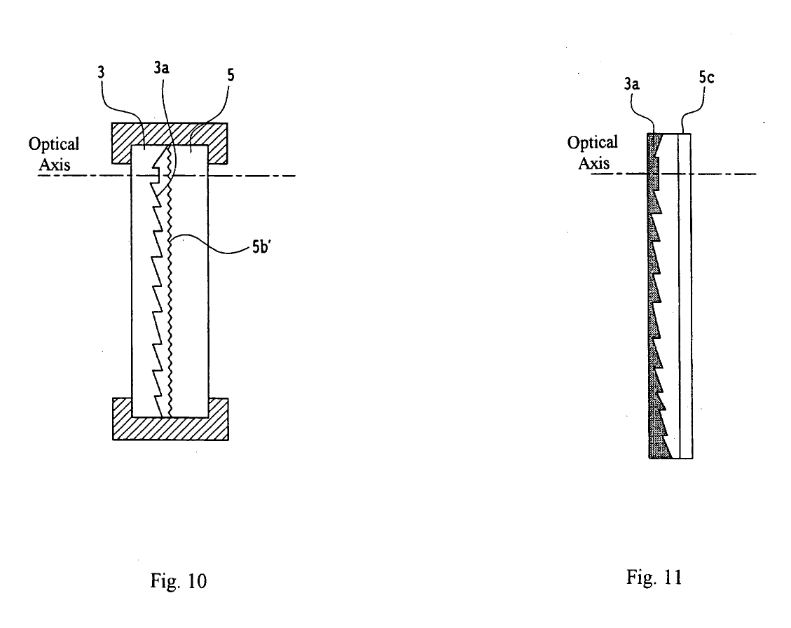

FIG. 10 is a side view to schematically show another example of a reflection-type display panel applicable to the reflection-type 3-D observation apparatus of the present invention. In the display panel of this example, the imaging optical system is formed of a front-surface Fresnel mirror, and the diffuser 5 is formed of a diffusing plate having a rough surface 5b′. With the display panel of this example, the Fresnel mirror surface 3a is on the front surface and is arranged to be very near the rough surface 5b′. This can significantly reduce the blurring of images. Alternatively, the display panel can be a front-surface Fresnel mirror with a diffusing film laminated thereto in lieu of using a diffusing plate, and with its diffusing surface very near to the Fresnel surface.

FIG. 11 is a side view to schematically show another example of a reflection-type display panel applicable to the reflection-type 3-D observation apparatus of the present invention. The display panel of this example is formed of a de-centered Fresnel back-surface mirror (as illustrated in FIG. 8b), but with a diffusing film 5c laminated thereto. The diffusing film 5c can be of the internal scattering-type or can use roughness formed on the front surface.

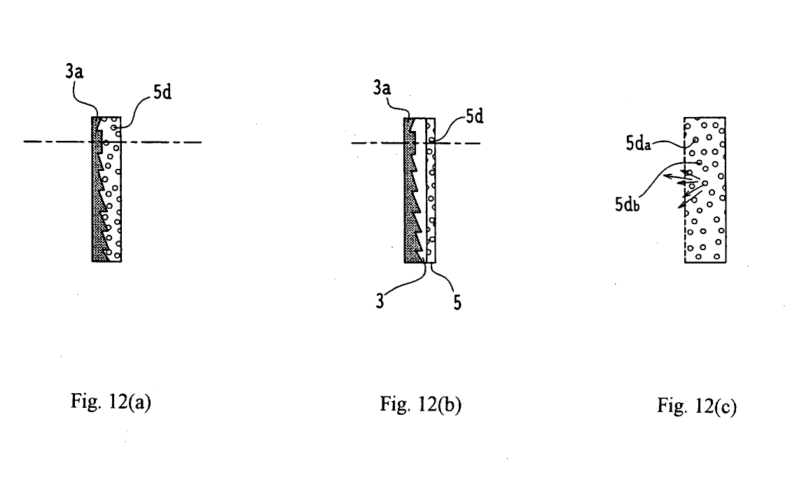

FIGS. 12(a)-12(c) are illustrations to show other examples of a reflection-type display panel applicable to the reflection-type 3-D observation apparatus of the present invention, with FIG. 12(a) being a side view to schematically show the structure, FIG. 12(b) being an illustration to schematically show a modification to the structure shown in FIG. 12(a), and FIG. 12(c) being an illustration to show diffusion in the display panel. As best shown in FIG. 12(c), the display panels of this example are of the internal diffusion-type, wherein the diffusing member is formed of a plastic matrix mixed with transparent fine grains 5da, 5db that have different refractive indexes. Light passing through the fine grains 5da, 5db is scattered. The display panel illustrated in FIG. 12 (a) is formed of an optical member having a Fresnel surface 3a forming a de-centered Fresnel back-surface mirror combined with plastic matrix material that is mixed with transparent fine grains. The de-centered Fresnel back-surface mirror and the internal diffusion-type diffusing member are integrally molded. The display panel illustrated in FIG. 12(b) is formed of a decentered Fresnel back-surface mirror and an internal diffusion-type diffusion plate formed by a plastic matrix being mixed with transparent fine grains. The de-centered Fresnel back-surface mirror and the internal diffusion-type diffusion plate are arranged very near one another. In the structure illustrated in FIG. 12(b), an internal diffusing film 5d is laminated onto the surface of a de-centered Fresnel back-surface mirror in lieu of using a diffusing plate.

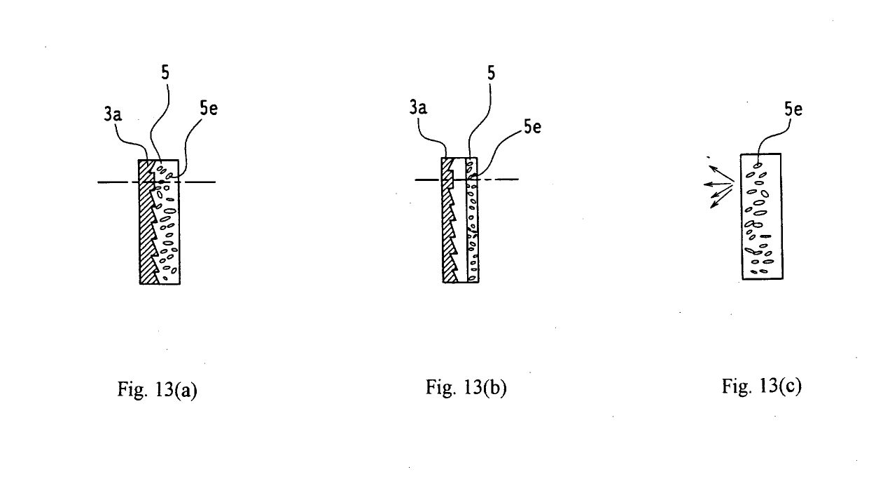

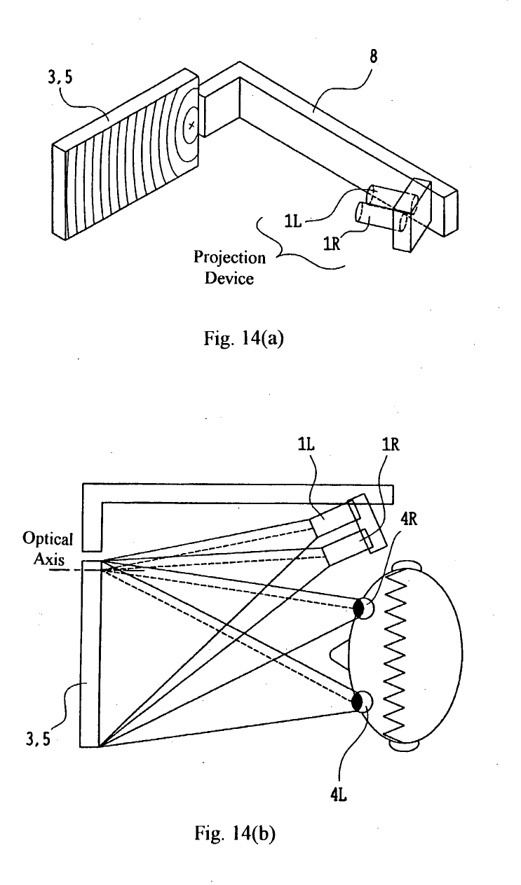

FIGS. 13(a)-13(c) are illustrations to show other examples of a reflection-type display panel applicable to the reflection-type 3-D observation apparatus of the present invention, with FIG. 13(a) being a side view to schematically show the structure, FIG. 13(b) being an illustration to schematically show a modification to the structure shown in FIG. 13(a), and FIG. 13(c) being an illustration to show the internal diffusion. The display panels shown in FIGS. 13(a)-13(c) are internal diffusion-type display panels in which the diffusion means 5 is a polymerized liquid crystal.

Polymerization is used to solidify liquid crystal. The present example uses this phenomenon. Polymerized liquid crystal 5e is birefringent and has an unstable orientation. When photopolymerized, it is solidified with a random internal orientation as is shown in FIG. 13(c). The display panel in FIG. 13(a) is formed of an optical member having a de-centered Fresnel back-surface mirror integrally molded with polymerized liquid crystal. The display panel in FIG. 13(b) is formed of a de-centered Fresnel back-surface mirror laminated on, or positioned near, a diffusion plate consisting of polymerized liquid crystal. A diffusing film consisting of polymerized liquid crystal can be laminated on the surface of the de-centered Fresnel back-surface mirror in place of the polymerized liquid crystal diffusion plate. With the display panel of this example having the structure as discussed above, the birefringent polymerized liquid crystal 5e is solidified with a random internal orientation. Light is slightly refracted according to the polarized direction. Scattering in the polymerized liquid crystal yields a diffusion effect as a whole. The display panel of this example can use a flat surface so that the diffusion effect due to internal dispersion is more efficiently used. This also makes it easy to clean when it gets dirty and to provide an anti-reflection coating for preventing reflection of ambient light.

FIGS. 14(a) and 14(b) are illustrations to show the arrangement of the reflection-type 3-D observation apparatus of the present invention having any of the structures shown in the examples above, with FIG. 14(a) being a perspective view and FIG. 14(b) being a top view. In the 3-D observation apparatus of this embodiment, the display panel is of the reflection-type. The display panel 3,5 and two projection devices 1R, 1L are integrally attached to a supporting member 8. The two projection devices 1R, 1L may be positioned on either the right or left side of the display panel 3,5, but for convenience of illustration are positioned on the right in FIGS. 14(a) and 14(b). The Fresnel reflecting surface of the display panel has its optical axis de-centered with respect to the center of the display surface. The de-centering may be either to the right or left, but for convenience of illustration is illustrated as being to the right in FIGS. 14(a) and 14(b). A sufficient angle is provided between the optical axis of the light entering the center of the display panel from the right and left projection devices versus the optical axis of the light emerging from the display panel to the viewer's respective right or left pupils 4R (4L) so that the projection devices and the viewer's head do not interfere with each other.

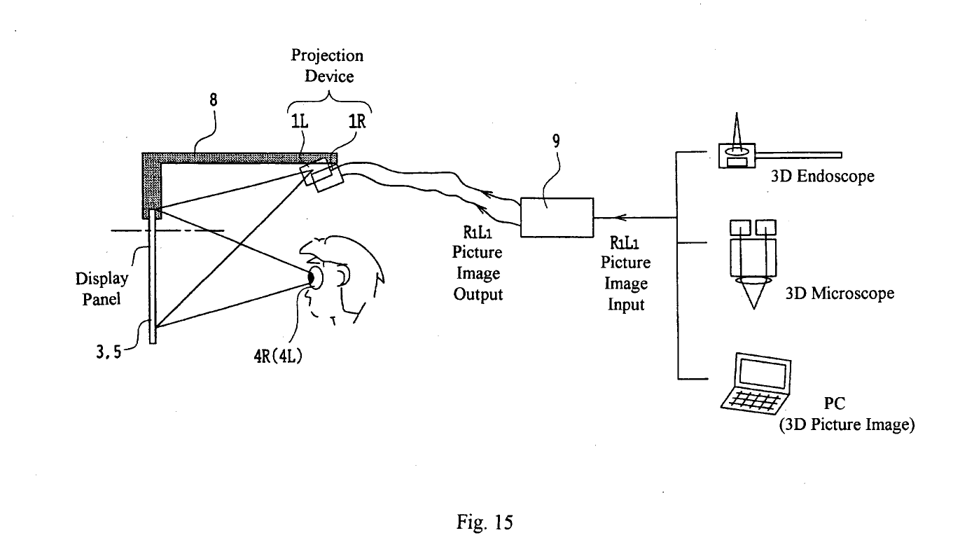

FIG. 15 is an illustration to schematically show the configuration of an embodiment of a reflection-type 3-D observation system using the 3-D observation apparatus of the present invention. However, the 3-D observation system of this embodiment can be applicable to all the 3-D observation apparatus of the present invention. The left and right projection devices of this embodiment are connected to a projection device control unit 9. The projection device control unit 9 selectively receives stereo pair image data, such as from a 3-D endoscope or 3-D microscope, and transfers this data to left and right projection devices. The projection device control unit 9 of this embodiment also can be used to receive 3-D parallax images generated by a personal computer so as to then display the images.

Applications of the 3-D observation apparatus of the present invention having the structure above will now be described.

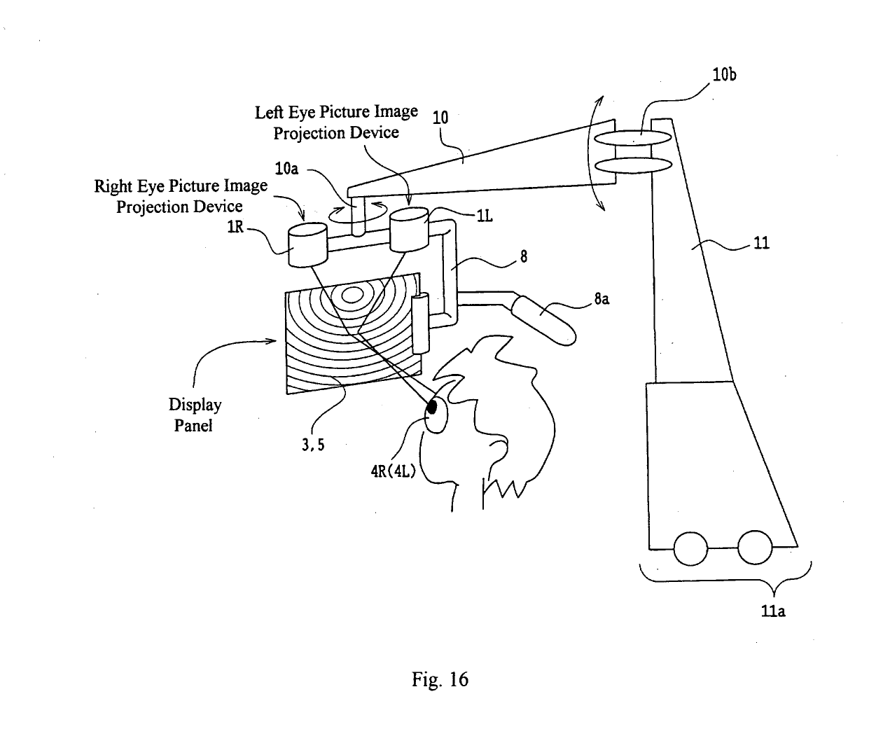

FIG. 16 is an illustration to show an application of the 3-D observation apparatus of the present invention, wherein a reflection-type observation apparatus is used. The observation apparatus includes a display panel 3,5, left and right projection devices 1L, 1R integrally attached to a holding member 8, a supporting arm 10 for supporting the holding member 8, and a supporting body 11 for supporting the supporting arm 10. With this 3-D observation apparatus, images having different parallax are projected onto the display panel from the left and right projection devices and reflected thereon. The reflected images are formed in the viewer's left and right pupils 4L, 4R with the viewing pupils enlarged. The holding member 8 is rotatable in the direction indicated by the arrow about the axis of a joint 10a. The supporting arm 10 is rotatable in the direction indicated by the arrow at the joints 10b. By rotating the holding member 8 and supporting arm 10 in the desired direction, the viewer may change his/her posture during observation. The holding member 8 has an operating handle 8a for easy grasping. The supporting body 11 has casters 11a so that the supporting body can be easily moved.

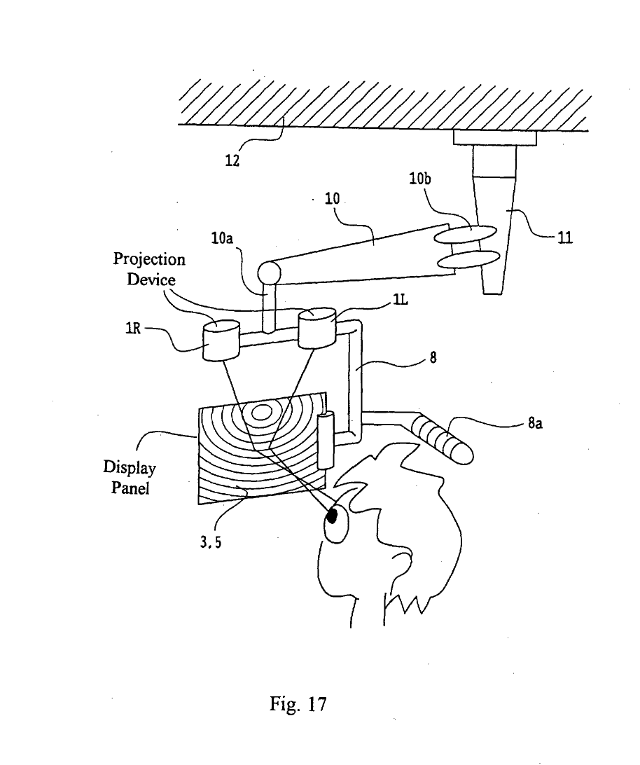

FIG. 17 is an illustration to show another application of a 3-D observation apparatus of the present invention. In this application, the supporting body 11 is attached to the ceiling in order to save space.

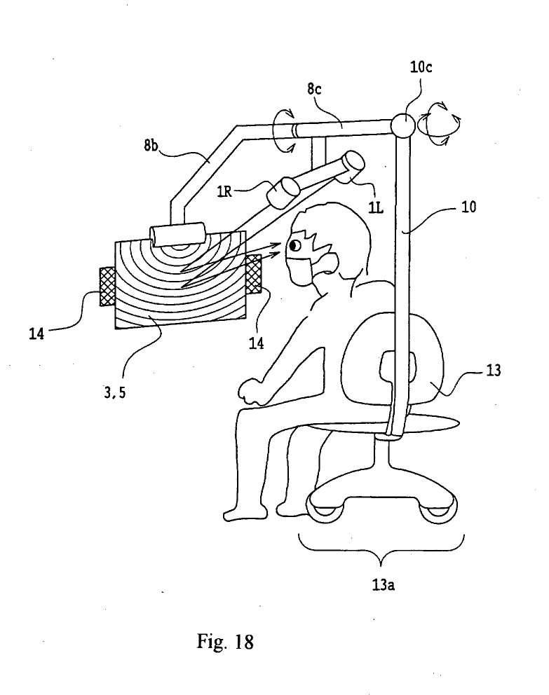

FIG. 18 is an illustration to show another application of the 3-D observation apparatus of the present invention. This application has the supporting arm 10 attached to a surgical chair 13. Here, the display panel is attached to a holding member 8b and the projection devices 1L, 1R are attached to a holding member 8c. The holding member 8b is rotatable relative to the holding member 8c. In this way, the direction of the display panel can be changed relative to the projection devices. The holding member 8c to which the projection devices are attached is rotatable in the two directions shown via a joint 10c. In this way, the display panel and projection devices can be re-oriented at will. Handles 14 are provided on the right and left sides of the display panel. In this way, re-orientation is easily accomplished without directly touching the display portion of the display panel. The surgical chair 13 has casters 13a so that the chair can be easily moved to change one's observation position.

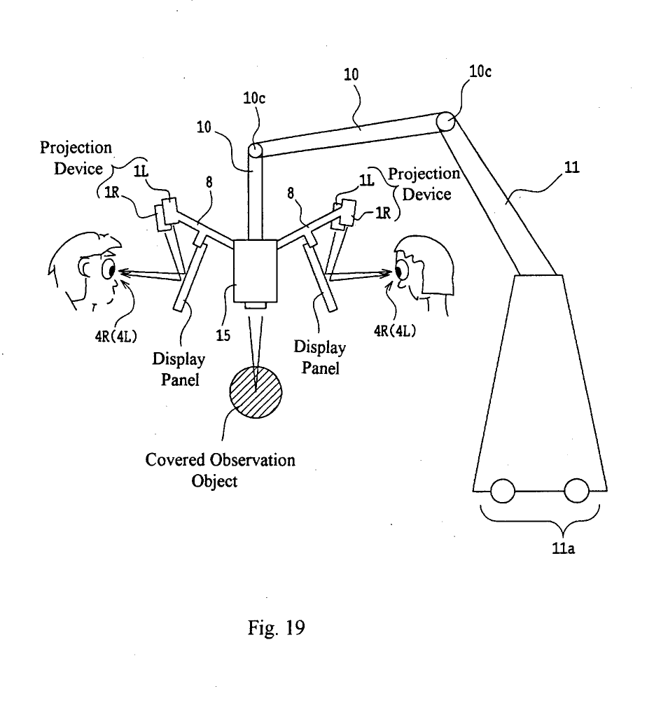

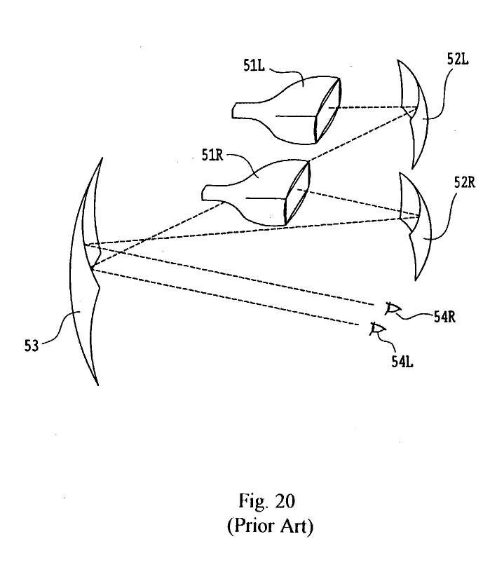

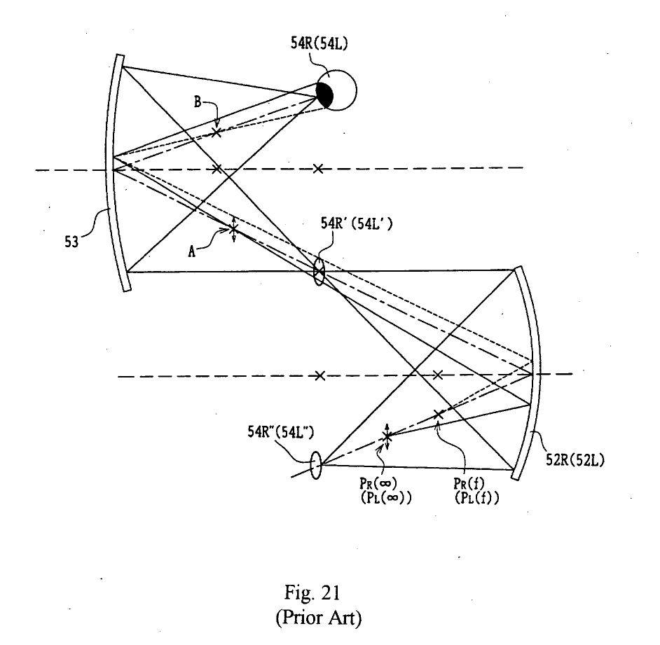

FIG. 19 is an illustration to show another application of the 3-D observation apparatus of the present invention. In this application, two 3-D observation apparatuses, each formed of projection devices 1L, 1R and a display panel attached to a holding member 8, are attached by means of the holding member 8 to the image input part 15 of a surgical microscope having a supporting body 11, casters 11a and a supporting arm 10 that is rotatable by means of joints 10c. Two cameras are contained in the image input part 15 of the surgical microscope. Input images are transferred to the respective projection devices of the 3-D observation apparatus. In this way, 3-D images from the surgical microscope are made simultaneously available to more than one viewer.

The 3-D observation apparatus applications shown in FIGS. 16 to 19 may be used in various fields, such as surgical microscopy, endoscopy, medical 3-D data imaging, 3D CAD imaging, and so on, or even as a computer game machine. Furthermore, the structures used in reflection-type 3-D observation apparatuses of the embodiments above are also applicable to transmission-type 3-D observation apparatuses using a transmission-type display panel as shown in FIG. 1 (a). In addition, the image display panel can instead be a DMD.

The invention being thus described, it will be obvious that the same may be varied in many ways. For example, the Fresnel lens, Fresnel mirror, and/or diffuser may formed holographically, as is known in the art, or a single holographic optical element can serve as both a Fresnel lens and diffuser, or as a Fresnel mirror and diffuser. In addition, low cost copies of such holographic components may be manufactured, as is known in the art. Rather, the scope of the invention shall be defined as set forth in the following claims and their legal equivalents. All such modifications as would be obvious to one skilled in the art are intended to be included within the scope of the following claims.

What is claimed is:

1. A 3-D observation apparatus comprising:
a projector device which projects light beams that convey left and right stereo images of an object through respective apertures so that the images overlap within a region; and
a Fresnel mirror having positive refractive power with its optical axis de-centered from the center of the Fresnel mirror;
wherein
the Fresnel mirror is positioned substantially at said region so that the Fresnel mirror forms images of the respective apertures, to thereby form conjugate regions which serve as exit pupils of the 3-D observation apparatus.

2. The 3-D observation apparatus according to claim 1, wherein a diffuser is provided substantially at the overlapping region for the purpose of enlarging said exit pupils.

3. The 3-D observation apparatus according to claim 2, wherein the diffuser is formed of an optical member having a non-uniform refractive index.

4. The 3-D observation apparatus according to claim 2, wherein the diffuser is formed of an optical member having a rough surface.

5. The 3-D observation apparatus according to claim 2, wherein the diffuser is formed of an optical member that includes a birefringent material.

6. The 3-D observation apparatus according to claim 1, wherein the projector device comprises two lens systems.

7. The 3-D observation apparatus according to claim 1, wherein the projector device comprises two display devices.

8. The 3-D observation apparatus according to claim 1, wherein the Fresnel mirror is aspheric, and the reflective surfaces of the Fresnel mirror have radii of curvature that increase near the periphery of the Fresnel mirror.

9. A 3-D observation apparatus comprising:
a projector device which projects light beams that convey left and right stereo images of an object through respective apertures so that the images overlap within a region; and
a Fresnel lens having positive refractive power with its optical axis de-centered from the center of the Fresnel lens;
wherein
the Fresnel lens is positioned substantially at said region so that the Fresnel lens forms images of the respective apertures to thereby form conjugate regions which serve as exit pupils of the 3-D observation apparatus.

10. The 3-D observation apparatus according to claim 9, wherein a diffuser is provided substantially at the overlapping region for the purpose of enlarging said exit pupils.

11. The 3-D observation apparatus according to claim 10, wherein the diffuser is formed of an optical member having a non-uniform refractive index.

12. The 3-D observation apparatus according to claim 10, wherein the diffuser is formed of an optical member having a rough surface.

13. The 3-D observation apparatus according to claim 10, wherein the diffuser is formed of an optical member that includes a birefringent material.

14. The 3-D observation apparatus according to claim 9, wherein the projector device comprises two lens systems.

15. The 3-D observation apparatus according to claim 9, wherein the projector device comprises two display devices.

16. The 3-D observation apparatus according to claim 9, wherein the Fresnel lens is aspheric, with its refractive surfaces having radii of curvature that increase near the periphery of the Fresnel lens.
